(19) United States
(12) Patent Application Publication
(10) Pub. No.: US 2011/0223427 A1
(43) Pub. Date: Sep. 15, 2011

(54) METHOD OF PRODUCING ELECTRICALLY INSULATING THERMALLY CONDUCTIVE SHEET, ELECTRICALLY INSULATING THERMALLY CONDUCTIVE SHEET, AND HEAT DISSIPATING MEMBER

(75) Inventors: Takashi Wano, Osaka (JP); Daisuke Kitagawa, Osaka (JP); Yoshinari Takayama, Osaka (JP)

(73) Assignee: NITTO DENKO CORPORATION, Ibaraki-shi, Osaka (JP)

(21) Appl. No.: 13/127,386

(22) PCT Filed: Nov. 12, 2009
(86) PCT No.: PCT/JP2009/069266

§ 371 Date: May 3, 2011

(30) Foreign Application Priority Data
Nov. 12, 2008 (JP) 2008-289989

(51) Int. Cl. B32B 27/00; B32B 27/06; B32B 38/18; C09K 5/14; B32B 37/10

(52) U.S. Cl. 428/421; 156/222; 156/306.3; 252/78.1

(57) ABSTRACT

The method of producing an electrically insulating thermally conductive sheet of the present invention includes the steps of (I) preparing a plurality of sheet materials consisting essentially of a fluororesin containing polytetrafluoroethylene, thermally conductive inorganic particles, and a forming aid; (II) stacking the plurality of sheet materials on one another and rolling the stacked sheet materials together; and (III) removing the forming aid. In the production method of the present invention, the step (I) and the step (II) may be repeated alternately. The sheet material that can be used in the production method of the present invention is, for example, a base sheet obtained by forming a mixture composed of a fluororesin containing polytetrafluoroethylene, thermally conductive inorganic particles, and a forming aid into a sheet, or a laminated sheet obtained by stacking a plurality of base sheets on one another and rolling them together.

### TECHNICAL FIELD

The present invention relates to a method of producing an electrically insulating thermally conductive sheet, an electrically insulating thermally conductive sheet, and a heat dissipating member.

### BACKGROUND ART

“Heat dissipation” is a major issue to be considered for electronic apparatuses, such as mobile computers and cellular phones, not only because the apparatus components themselves generate more heat as the processing capabilities of the apparatus increase, but also because the components are packaged more densely as the sizes of the apparatuses are reduced.

A new concept of an efficient heat diffusion/heat transfer system has appeared to maintain the operating characteristics, reliability, etc. of semiconductor devices or the like, and various approaches have been proposed.

For example, a known heat dissipating member is a sheet or the like made of silicone-based grease or silicone gel containing a thermally conductive filler (see, for example, Patent Literature 1).

Pasty materials such as silicone-based grease are superior in their ability to reduce the contact thermal resistance. These materials, however, require an application process because they are pasty, and variations in this application process affect the thermal conductivity of the heat dissipating member, which is a disadvantage of the pasty materials. In addition, these pasty materials have handling problems such as running of the applied paste.

On the other hand, silicone gel is superior in handling properties, but has a disadvantage in that if the content of a filler is increased to increase the thermal conductivity, the strength of the resulting sheet decreases and only a small force ruptures the sheet.

There has been proposed another electrically insulating, highly thermally conductive sheet made of a composition composed of a thermally conductive inorganic powder and a binder containing synthetic rubber and polytetrafluoroethylene (hereinafter referred to as “PTFE”) (see Patent Literature 2). Since this insulating sheet has excellent formability and high mechanical strength, it also can achieve even higher thermal conductivity.

However, when the insulating sheet contains synthetic rubber as mentioned above, it requires a vulcanization process, and this vulcanization process causes a problem that a peroxide or the like added as a vulcanizing agent remains in the sheet and this residue causes adverse effects on an electronic apparatus when the sheet is used in the electronic apparatus. In addition, the thermal resistance cannot be reduced sufficiently due to the presence of the rubber. More specifically, even when the content of the thermally conductive inorganic powder is increased, the thermal resistance can only be reduced to about 0.3 K/W, which makes it difficult to obtain sufficiently high heat dissipation capability.

Another example of highly thermally conductive materials is graphite, although it is an electrically conductive material. In a thin electronic apparatus such as a cellular phone, a graphite sheet is preferably used because it has a high in-plane thermal conductivity of 370 to 1500 W/mK in spite of its small thickness and is the most suitable material for heat diffusion or heat dissipation (see Patent Literatures 3 and 4).

Since almost all mobile apparatuses, including cellular phones, have been developed focusing on reductions in thickness and weight, the importance of the measures to prevent the formation of heat spots has increased. Therefore, the use of graphite sheets, having a heat dissipation function suitable for this purpose, has been widespread.

A graphite sheet, however, has low surface strength and is susceptible to surface delamination and abrasion, which causes a problem. In addition, since graphite is an electrically conductive material, it affects the operation of an electronic apparatus when it comes into contact with the circuit board in the electronic apparatus. For these reasons, the upper and lower surfaces of a graphite sheet are covered with thin covering layers made of different materials, and the resulting sheet is used as a heat dissipating member. This means that the graphite sheet cannot be used unless the upper and lower surfaces thereof are covered with insulating layers, although graphite itself has high heat dissipation capability, and therefore it is inferior in handling properties, which is disadvantageous.

It is conceivable to use a ceramic material to prevent the formation of heat spots. However, since a ceramic material is not flexible, the resulting ceramic sheet cracks when it is mounted or during transport.

### CITATION LIST

### Patent Literature

Patent Literature 1 JP 2005-228955 A
Patent Literature 2 JP 63-046524 B
Patent Literature 3 JP 2008-060527 A
Patent Literature 4 JP 2008-078380 A

### SUMMARY OF INVENTION

### Technical Problem

It is therefore an object of the present invention to provide an electrically insulating thermally conductive sheet having no adverse effect on an electronic apparatus when it is used therein, having high heat dissipation capability and high mechanical strength, and further having excellent handling properties. It is a further object of the present invention to provide a heat dissipating member capable of rapidly diffusing (transferring) heat generated in a heat generating component so as to suppress a rise in the temperature of the heat generating component, and having excellent handling properties.

### Solution to Problem

The method of producing an electrically insulating thermally conductive sheet of the present invention includes the steps of (I) preparing a plurality of sheet materials consisting essentially of a fluororesin containing PTFE, thermally conductive inorganic particles, and a forming aid; (II) stacking the plurality of sheet materials on one another and rolling the stacked sheet materials together; and (III) removing the forming aid. In the production method of the present invention, “a sheet material consisting essentially of a fluororesin containing PTFE, thermally conductive inorganic particles, and a forming aid” means a sheet material containing no materials other than the fluororesin, the thermally conductive inorganic particles, and the forming aid, or a sheet material containing only a very small amount (for example, 10% by weight or less) of the other materials, if any, so that the properties (thermal conductive properties) of the resulting electrically insulating thermally conductive sheet are not significantly impaired, compared with the properties that would be expected if no other materials were contained.

The electrically insulating thermally conductive sheet of the present invention is a sheet consisting essentially of a fluororesin containing PTFE, and thermally conductive inorganic particles. The sheet has an in-plane thermal conductivity of 5 to 50 W/mK, a through-thickness thermal conductivity of 1 to 15 W/mK, and a withstand voltage of 5 kV/mm or more. In the electrically insulating thermally conductive sheet of the present invention, “a sheet consisting essentially of a fluororesin containing PTFE, and thermally conductive inorganic particles” means a sheet containing no materials other than the fluororesin and the thermally conductive inorganic particles, or a sheet containing only a very small amount (for example, 10% by weight or less) of the other materials, if any, so that the properties (thermal conductive properties) of the resulting electrically insulating thermally conductive sheet are not significantly impaired, compared with the properties that would be expected if no other materials were contained.

The present invention further provides an electrically insulating thermally conductive sheet obtained by the method of producing an electrically insulating thermally conductive sheet of the present invention described above.

The present invention further provides a heat dissipating member including the electrically insulating thermally conductive sheet of the present invention described above.

### Advantageous Effects of Invention

In the electrically insulating thermally conductive sheet obtained by the production method of the present invention, only a fluororesin is essentially used as a matrix, and no impurities such as other organic materials, rubber components, and a vulcanizing agent are contained. Therefore, there is no need to consider the effects of these impurities on an electronic apparatus when the sheet is used therein. In the electrically insulating thermally conductive sheet obtained by the production method of the present invention, the in-plane thermal conductivity is higher than the through-thickness thermal conductivity. This thermal conductivity anisotropy makes it possible to diffuse heat rapidly in the in-plane direction so as to increase the heat dissipation area, thus achieving high heat dissipation capability. Furthermore, according to the production method of the present invention, an electrically insulating thermally conductive sheet having sufficient mechanical strength can be obtained, even if the sheet has a high content of thermally conductive inorganic particles. As described above, the present invention can provide an electrically insulating thermally conductive sheet having no adverse effect on an electronic apparatus when it is used therein, having high heat dissipation capability and high mechanical strength, and further having excellent handling properties.

The heat dissipating member of the present invention, which includes the electrically insulating thermally conductive sheet having the above-mentioned properties, has not only electrical insulating properties but also high heat dissipation capability. Therefore, the heat dissipating member of the present invention also can be used in an electronic apparatus that requires electrical insulation. This heat dissipating member has excellent handling properties, and can rapidly diffuse (transfer) heat generated in a heat generating component so as to cool the heat generating component, thus suppressing a local temperature rise.

### DESCRIPTION OF EMBODIMENTS

Hereinafter, the embodiments of the present invention are described. It should be noted that the following descriptions are not intended to limit the present invention.

The method of producing an electrically insulating thermally conductive sheet of the present embodiment includes: (I) preparing a plurality of sheet materials consisting essentially of a fluororesin containing PTFE, thermally conductive inorganic particles, and a forming aid; (II) stacking the plurality of sheet materials on one another and rolling the stacked sheet materials together; and (III) removing the forming aid.

The method of producing an electrically insulating thermally conductive sheet of the present embodiment may further include the step (step (IV)) of press-forming a sheet article obtained in the step (III). It is desirable that in the step (IV), the sheet article be press-formed at a temperature within a temperature range for sintering PTFE.

An example of the step (I) is described.

First, an example of the sheet material to be prepared in the step (I) is described.

First, a fluororesin containing PTFE is prepared. This fluororesin may consist of PTFE, or may be a mixture of PTFE and another fluororesin. Preferably, the fluororesin contains at least 5% by weight of PTFE, and more preferably at least 10% by weight of PTFE. Preferably, another fluororesin to be mixed with PTFE has a melting point of 250° C. or higher because of concerns over the formation of pyrolysis products. It is preferable to use, as another fluororesin, a melt-processable fluororesin having good compatibility with PTFE, for example, a tetrafluoroethylene-perfluoroalkyl vinyl ether copolymer (hereinafter referred to as “PFA”), a tetrafluoroethylene-hexafluoropropyrene copolymer (hereinafter referred to as “FEP”), etc. The use of such a melt-processable fluororesin reduces the porosity efficiently in the later hot pressing step (the step 1V), resulting in a further increase in the thermal conductivity. Therefore, for example, (A) a fluororesin composed of PTFE, (B) a fluororesin composed of PTFE and PFA, or (C) a fluororesin composed of PTFE and FEP, is used suitably for the formation of the sheet materials.

Thermally conductive inorganic particles and a forming aid are mixed with the fluororesin that has been prepared as described above so as to obtain a pasty mixture. Desirably, this mixture is obtained under conditions such that the fibrillation of PTFE can be prevented from occurring as much as possible. More specifically, it is desirable not to knead the mixture but to mix the materials for a short time at a low rotation speed so as to prevent PTFE from being subjected to a shear force. If the fibrillation of PTFE occurs during the mixing of the materials, already-formed fibrils of PTFE are cut during the rolling of the step (II), which may cause a breakdown of the network structure of PTFE and thus make it difficult to maintain the shape of the sheet. Therefore, when the mixture is prepared in such a manner as to prevent the fibrillation of PTFE, the sheet material containing PTFE as its matrix can be formed easily in the following step.

Preferably, the thermally conductive inorganic particles are formed of an inorganic material having a thermal conductivity of 1 to 200 W/mK so as to allow the resulting electrically insulating thermally conductive sheet to have sufficient thermal conductivity. Preferably, the thermally conductive inorganic particles are formed of an inorganic material having an electric resistivity of 10¹⁰ to 10¹⁷ Ω·m so as to allow the resulting electrically insulating thermally conductive sheet to have high electrical insulation. For the thermally conductive inorganic particles of the present embodiment, boron nitride is suitably used because it has a high thermal conductivity and a high electric resistivity. Therefore, it is preferable that the thermally conductive inorganic particles of the present embodiment consist essentially of boron nitride. As stated herein, the “thermally conductive inorganic particles consisting essentially of boron nitride” means thermally conductive inorganic particles containing no materials other than boron nitride, or thermally conductive inorganic particles containing only a very small amount (for example, 10% by weight or less) of the other materials, if any, so that the properties (thermal conductive properties) of the resulting electrically insulating thermally conductive sheet are not significantly impaired, compared with the properties that would be expected if no other materials were contained.

The shape of the thermally conductive inorganic particles is not particularly limited. Preferable shape of the thermally conductive inorganic particles is flat or flaky to obtain an electrically insulating thermally conductive sheet having thermal conductivity anisotropy, because such flat or flaky particles tend to be aligned in the in-plane direction by rolling. It is also preferable that the thermally conductive inorganic particles themselves have thermal conductivity anisotropy for the same reason. Furthermore, agglomerates of thermally conductive inorganic particles available from various suppliers also may be used to increase the through-thickness thermal conductivity.

Preferably, the thermally conductive inorganic particles are added so that the resulting electrically insulating thermally conductive sheet contains 40 to 95% by weight of the particles, and more preferably contains 60% by weight or more thereof. When the content of the thermally conductive inorganic particles is adjusted to this range, the in-plane thermal conductivity of the sheet can be increased to a sufficiently high level. As a result, higher heat dissipation capability can be obtained.

The particle size of the thermally conductive inorganic particles is not particularly limited as long as the particles can be supported by the PTFE matrix without falling off and allow the resulting electrically insulating thermally conductive sheet to have sufficiently high thermal conductivity. For example, the thermally conductive inorganic particles desirably have a particle size of 0.3 to 500 μm. However, the thermally conductive inorganic particles preferably have a larger particle size to increase the thermal conductivity. This is because, when thermally conductive inorganic particles having a larger particle size are used without having their content changed, the number of interfaces between the particles is reduced, which reduces the thermal resistance. As stated herein, the particle size is a value measured with a laser diffraction-scattering particle size distribution analyzer (Microtrac).

As a forming aid, saturated hydrocarbons such as dodecane and decane can be used, for example. The forming aid can be added in an amount of 20 to 55% by weight with respect to the total weight of the resulting mixture. This mixture is extruded and rolled into sheet form to obtain a base sheet. Thus, the base sheet can be used as the sheet material of the present invention (the first example of the sheet material). The sheet material thus obtained has a thickness, for example, of 0.5 to 5 mm.

As another example of the sheet material to be prepared in the step (I), there can be mentioned a laminated sheet (the second example of the sheet material) obtained by stacking a plurality of the above-mentioned base sheets on one another and rolling them together. The number of layers in the laminated sheet is not particularly limited, and can be determined appropriately in consideration of the number of constituent layers of the electrically insulating thermally conductive sheet (the number of layers that form the electrically insulating thermally conductive sheet) intended to be produced.

The sheet material may contain a trace amount of materials other than the fluororesin, the thermally conductive inorganic particles, and the forming aid, but the sheet material preferably consists of the fluororesin, the thermally conductive inorganic particles, and the forming aid in order to achieve the advantageous effects of the present invention efficiently.

The sheet material can be prepared in the manner as described above.

Next, an example of the step (II) is described.

In the step (II), the plurality of sheet materials prepared in the step (I) are stacked on one another and then rolled together. Specifically, the plurality of sheet materials prepared in the step (I) are stacked on one another, and the stacked sheet materials are rolled together to form a laminated sheet. As mentioned above, the sheet material may be the above-mentioned base sheet (the first example of the sheet material), or may be a laminated sheet (the second example of the sheet material) obtained by stacking a plurality of base sheets on one another and rolling the stacked base sheets together. The number of sheet materials to be stacked on one another in the step (II) is not particularly limited. For example, about 2 to 10 sheet materials can be stacked on one another. Desirably, a pair of sheet materials are stacked on each other and then the stacked sheet materials are rolled together to achieve high strength.

In the method of producing an electrically insulating thermally conductive sheet of the present embodiment, the step (I) and the step (II) may be repeated alternately. A specific example of this case is described below.

First, a plurality of base sheets (e.g., 2 to 10 sheets) are prepared (step (I)). Next, the plurality of base sheets are stacked, and the stacked base sheets are rolled together into a laminated sheet (first laminated sheet) (step (II)). Then, a plurality of first laminated sheets (e.g., 2 to 10 sheets) thus obtained are prepared for use as the sheet materials in the step (I). Next, the plurality of first laminated sheets (e.g., 2 to 10 sheets) are stacked, and the stacked first laminated sheets are rolled together into a laminated sheet (second laminated sheet) (step (II)). Then, a plurality of second laminated sheets (e.g., 2 to 10 sheets) thus obtained are prepared for use as the sheet materials in the step (I). Next, the plurality of second laminated sheets (e.g., 2 to 10 sheets) are stacked, and the stacked second laminated sheets are rolled together into a laminated sheet (third laminated sheet) (step (II)). In this way, the step (I) and the step (II) can be repeated alternately until the desired number of constituent layers of the electrically insulating thermally conductive sheet are obtained. In the embodiment described above, the laminated sheets each having the same number of layers (the first laminated sheets, or the second laminated sheets, for example) are stacked and rolled together. However, laminated sheets with different numbers of layers also may be stacked and rolled together.

Preferably, the rolling direction is changed each time the step (II) is repeated. For example, when the rolling is performed to obtain the second laminated sheet, the rolling direction can be changed by 90 degrees from the rolling direction that has been employed to obtain the first laminated sheet. The PTFE network is extended both longitudinally and transversely by changing the rolling direction repeatedly, so that the sheet strength can be increased and the thermally conductive inorganic particles can be fixed firmly to the PTFE matrix.

The number of constituent layers of the electrically insulating thermally conductive sheet can be, for example, 2 to 5000, when it is expressed in terms of the total number of base sheets included in the electrically insulating thermally conductive sheet. In order to increase the sheet strength, the number of layers is desirably 200 or more. In order to reduce the sheet thickness (e.g., 1 mm or less), the number of layers is desirably 1500 or less. The more the number of constituent layers is increased, the more the strength of the resulting sheet can be enhanced.

At an early stage of rolling (at a stage where the total number of base sheets to be included is small), the sheet is not yet strong enough to withstand rolling with a high rolling ratio. However, as the stacking and rolling of the sheet materials are repeated, the resulting sheet can withstand rolling with a higher rolling ratio. As a result, the sheet strength can be increased and the thermally conductive inorganic particles can be fixed firmly to the PTFE matrix. In addition, the laminated structure (i.e., the number of constituent layers) also is related to the thermal conductivity and electrical insulation of the resulting sheet. Accordingly, the number of constituent layers is preferably 10 to 1000 in order to obtain a sheet with sufficient thermal conductivity and electrical insulation.

Finally, a sheet with a thickness of about 0.1 to 3 mm is produced, and then the sheet is heated to remove the forming aid in the step (III). Thus, the electrically insulating thermally conductive sheet of the present invention can be obtained.

The sheet article obtained by removing the forming aid in the step (III) may be press-formed (the step (IV)). This press-forming step can eliminate the pores, and thus contributes to the increase in thermal conductivity. In other words, it is desirable to reduce the porosity of the resulting electrically insulating thermally conductive sheet to further increase the thermal conductivity of the sheet. For example, the porosity is desirably 30% or less. As stated herein, the porosity is a value obtained by the measurement method employed in the examples below. It is desirable, in the step (III), to press-form the sheet article at a temperature within a temperature range for sintering PTFE. The porosity can be reduced efficiently by performing the press-forming at this sintering temperature.

In the production method of the present embodiment, when the fluororesin, the thermally conductive inorganic particles, and the forming aid are mixed to obtain a pasty mixture, this mixing is performed under conditions such that the fibrillation of PTFE can be prevented from occurring as much as possible. As a result, during the rolling in the following step (II), the formation of the mixture into a sheet and the fibrillation of PTFE proceed simultaneously. Therefore, during the rolling in the step (II), the thermally conductive inorganic particles are subjected to the pressure of rolling without being entangled with the PTFE fibrils, and then aligned in the direction approximately parallel to the sheet. When flaky particles are used as the thermally conductive inorganic particles, the particles are aligned in the rolling direction during the rolling, which further increases the in-plane thermal conductivity. Furthermore, when the particles having thermal conductivity anisotropy, like boron nitride particles, are used, the in-plane thermal conductivity can be further increased. This alignment of the thermally conductive inorganic particles produces thermal conductivity anisotropy in the resulting electrically insulating thermally conductive sheet. According to the production method of the present embodiment, an electrically insulating thermally conductive sheet having an in-plane thermal conductivity higher than a through-thickness thermal conductivity can be obtained. The electrically insulating thermally conductive sheet obtained in the present embodiment is, for example, a sheet consisting essentially of a fluororesin containing PTFE and thermally conductive inorganic particles, having an in-plane thermal conductivity of 5 to 50 W/mK, a through-thickness thermal conductivity of 1 to 15 W/mK, and a withstand voltage of 5 kV/mm or more. Since the in-plane thermal conductivity of this electrically insulating thermally conductive sheet is higher than the through-thickness thermal conductivity, heat is diffused rapidly in the in-plane direction to increase the heat dissipation area, and therefore high heat dissipation capability can be obtained. Thus, it has been found that the sheet produced by the production method of the present invention has electrical insulating properties and offers excellent thermal diffusivity.

In the electrically insulating thermally conductive sheet obtained by the production method of the present embodiment, only a fluororesin is used as a matrix, and no impurities such as other organic materials, rubber components, and a vulcanizing agent are contained. Therefore, there is no need to consider the effects of these impurities on an electronic apparatus when the sheet is used therein. In addition, since the in-plane thermal conductivity of this sheet is high, it is most suitable for heat diffusion and heat dissipation. Therefore, a sheet having both electrical insulating properties and a high thermal diffusion function can be obtained. In addition, this electrically insulating thermally conductive sheet also has high mechanical strength. Therefore, even if the sheet has a high content of thermally conductive inorganic particles, sufficiently high mechanical strength can be obtained.

According to the production method of the present embodiment, an electrically insulating thermally conductive sheet having a tensile elongation of 1 to 400% can be produced. As stated herein, the tensile elongation means the percentage of elongation of a test sample measured when the test sample is broken (ruptured) while it is being stretched at a rate of 100 mm/min by a tensile tester. The tensile elongation can be calculated by the following equation:

Tensile elongation(%)=100×(L−L₀)/L₀

where L₀ is the length of a test sample before test, and L is the length of the test sample at rupture.

Since this electrically insulating thermally conductive sheet can achieve such a high tensile elongation, it can be placed as a heat dissipating member in a desired location in an electronic apparatus, regardless of the shape of the location.

In the production method of the present embodiment, fibrillation of PTFE does not so much proceed during the mixing of the materials. Therefore, even if the step (II) of rolling is repeated, there occurs no problem that the fibrils of PTFE are cut and the shape of the sheet cannot be maintained. Thus, it is easy to maintain the shape of the sheet. Furthermore, in the present embodiment, a plurality of sheet materials are stacked on one another and the stacked sheet materials are rolled together. Therefore, even if some of the layers are flawed by rolling, other layers can compensate for the flaws. Thus, there occurs no problem that the shape of the sheet cannot be maintained. In addition, in the present embodiment, since the rolling direction is changed each time the step (II) is repeated, PTFE is cured in an isotropic manner, and a flawless sheet is obtained. For these reasons, the production method of the present embodiment enables a long sheet or a continuous sheet to be obtained.

Furthermore, since the electrically insulating thermally conductive sheet produced by the production method of the present embodiment has electrically insulating properties and a high thermal diffusion function, a heat dissipating member including such an electrically insulating thermally conductive sheet also can be provided. This heat dissipating member may be a heat dissipating sheet composed of an electrically insulating thermally conductive sheet, or may be composed of an electrically insulating thermally conductive sheet and another constituent element such as a metal plate.

### EXAMPLES

Next, the method of producing an electrically insulating thermally conductive sheet and the electrically insulating thermally conductive sheet of the present invention are described specifically by way of examples.

### Example 1

Boron nitride (BN) particles as thermally conductive inorganic particles (“HP-40” (trade name) manufactured by Mizushima Ferroalloy Co., Ltd.) and PTFE (“F104U” (trade name) manufactured by Daikin Industries, Ltd.) were mixed in a ratio (weight ratio) of 90:10. More specifically, they were mixed so that the content of the BN particles in the resulting electrically insulating thermally conductive sheet was 90% by weight. As a forming aid, decane was added in an amount of 40% by weight. These materials were mixed under conditions such that the fibrillation of PTFE can be prevented from occurring as much as possible. The mixing was performed under the conditions of a rotation speed of 10 rpm, a temperature of 24° C., and a mixing time of 5 minutes in a V-blender. The resulting mixture was pressed between a pair of rolls and formed into an elliptical base sheet (sheet material) with a thickness of 3 mm, a width of 50 mm, and a length of 150 mm.

First, two base sheets were stacked, and the stacked sheets were pressed together between the rolls and formed into a laminated sheet (first laminated sheet). Next, two first laminated sheets thus obtained were prepared as sheet materials. These two first laminated sheets were stacked on each other, and the stacked sheets were rolled together. Thus, a new laminated sheet (second laminated sheet) was obtained. Next, two second laminated sheets thus obtained were prepared as sheet materials. These two second laminated sheets were stacked on each other, and the stacked sheets were rolled together in the direction shifted by 90 degrees from the first rolling direction. Thus, a new laminated sheet (third laminated sheet) was obtained. In this way, the step of stacking the obtained laminated sheets as sheet materials on each other and rolling them together was repeated 5 times while the rolling direction was changed by 90 degrees each time. Then, the resulting laminated sheet was rolled several times while the gap between the rolls was reduced by 0.5 mm each time. Finally, a sheet article with a thickness of about 1 mm was obtained.

Subsequently, the sheet article thus obtained was heated at 150° C. for 30 minutes to remove the forming aid. Next, this sheet article was press-formed at 380° C. and 10 MPa for 5 minutes. Thus, an electrically insulating thermally conductive sheet of Example 1 was obtained.

The thermal conductivity, the tensile elongation, and the dielectric breakdown voltage of the electrically insulating thermally conductive sheet of Example 1 thus produced were measured. Table 1 shows the measurement results.

<Measurement of Thermal Conductivity>

The in-plane thermal conductivity and the through-thickness thermal conductivity of the sheet were each measured by a laser flash method. First, the thermal diffusivity was measured with a xenon flash analyzer “LFA 447 NanoFlash (registered trademark)” manufactured by NETZSCH). The thermal conductivity was calculated based on this measured value of the thermal diffusivity by the following equation. In the following equation, a value obtained by dividing the weight by the volume was used as a density. The specific heat was additionally measured with a DSC (“DSC 200 F3 Maia (registered trademark)” manufactured by NETZSCH), and as a result, regarded as 0.8. Table 1 also shows the values of the densities and specific heats.

Thermal conductivity(W/mK)=thermal diffusivity(mm²/s)×specific heat(J/g·K)×density(g/cm³)

<Tensile Elongation>

A test sample (with a width of 10 mm and a length of 50 mm (=L₀)) was stretched at a rate of 100 mm/min in the lengthwise direction by a tensile tester “Tensilon” (manufactured by Orientec Corporation), and the length (L) of the test sample at break (rupture) was measured. The measurement was performed at room temperature, and the distance between chucks was 20 mm. The tensile elongation was calculated by the following equation:

Tensile elongation(%)=100×(L−L₀)/L₀

<Dielectric Breakdown Voltage>

The dielectric breakdown voltage was measured according to JIS K-6245.

### Example 2

In Example 2, an electrically insulating thermally conductive sheet was produced in the same manner as in Example 1, except that BN particles and PTFE were mixed in a ratio (weight ratio) of 70:30. More specifically, they were mixed so that the content of the BN particles in the resulting electrically insulating thermally conductive sheet was 70% by weight. The thermal conductivity, the tensile elongation, and the dielectric breakdown voltage of this sheet were measured in the same manner as in Example 1. Table 1 shows the measurement results.

### Example 3

In Example 3, an electrically insulating thermally conductive sheet was produced in the same manner as in Example 1, except that BN particles and PTFE were mixed in a ratio (weight ratio) of 50:50. More specifically, they were mixed so that the content of the BN particles in the resulting electrically insulating thermally conductive sheet was 50% by weight. The thermal conductivity, the tensile elongation, and the dielectric breakdown voltage of this sheet were measured in the same manner as in Example 1. Table 1 shows the measurement results.

### Example 4

In Example 4, an electrically insulating thermally conductive sheet was produced in the same manner as in Example 1, except that BN particles and PTFE were mixed in a ratio (weight ratio) of 80:20. More specifically, they were mixed so that the content of the BN particles in the resulting electrically insulating thermally conductive sheet was 80% by weight. The thermal conductivity, the tensile elongation, and the dielectric breakdown voltage of this sheet were measured in the same manner as in Example 1. Table 1 shows the measurement results.

### Example 5

In Example 5, an electrically insulating thermally conductive sheet was produced in the same manner as in Example 1, except that press-forming was performed under a pressure of 25 MPa after the removal of a forming aid. The thermal conductivity, the tensile elongation, and the dielectric breakdown voltage of this sheet were measured in the same manner as in Example 1. Table 1 shows the measurement results.

### Comparative Example 1

A silicone resin (“SE 1886” (trade name) manufactured by Dow Corning Toray Co., Ltd.), a silicone oil (“KF-96-100CS” (trade name) manufactured by Shin-Etsu Chemical Co., Ltd.), and BN particles (“HP-40” (trade name) manufactured by Mizushima Ferroalloy Co., Ltd.) were mixed in a ratio (weight ratio) of 10:50:80. The resulting mixture was applied to a Kapton film, and press-formed at 150° C. and 2 MPa into a sheet with a thickness of about 1 mm. The thermal conductivity, the tensile elongation, and the dielectric breakdown voltage of this sheet also were measured in the same manner as in Example 1. Table 1 shows the measurement results.

TABLE 1

| | | | | | | Comparative |
|---|---|---|---|---|---|---|
| | Example 1 | Example 2 | Example 3 | Example 4 | Example 5 | Example 1 |
| BN particles/PTFE | 90/10 | 70/30 | 50/50 | 80/20 | 90/10 | — |
| (weight ratio) | | | | | | |
| In-plane thermal | 9.9 | 7.7 | 5.9 | 11.4 | 17.6 | 3 |
| conductivity | | | | | | |
| (W/mK) | | | | | | |
| Through-thickness thermal | 6.4 | 5.0 | 2.4 | 6.6 | 11.9 | 3 |
| conductivity | | | | | | |
| (W/mK) | | | | | | |
| Dielectric breakdown voltage | 10.4 | 18.3 | 27 | 10.8 | 22.0 | 10 |
| (kV/mm) | | | | | | |
| Tensile elongation | 2 | 330 | 550 | 20 | 2 | 0 |
| (%) | | | | | | |
| Density | 1.54 | 1.88 | 2.01 | 1.71 | 1.81 | 2.21 |
| (g/cm³) | | | | | | |
| Specific heat | 0.8 | 0.8 | 0.8 | 0.8 | 0.8 | 0.8 |
| (J/g · K) | | | | | | |

The results shown in Table 1 demonstrate that the electrically insulating thermally conductive sheets, each produced by the production method of the present invention and composed of PTFE and thermally conductive inorganic particles (BN particles), can achieve in-plane thermal conductivities of 5 to 50 W/mK and through-thickness thermal conductivities of 1 to 15 W/mK, and dielectric breakdown voltages (withstand voltages) of 5 kV/mm or higher. Each of the electrically insulating thermally conductive sheets of Examples 1, 2, 4, and 5 containing 60% by weight or more of thermally conductive inorganic particles (BN particles) has both a high in-plane thermal conductivity and a high through-thickness thermal conductivity with a large difference therebetween. Therefore, these sheets are considered to have high heat dissipation capabilities.

Next, in Examples 6 to 11 below, different types of fluororesins and thermally conductive inorganic particles were used to obtain electrically insulating thermally conductive sheets, and then the thermal conductivities and the porosities of these sheets were measured.

### Example 6

In Example 6, an electrically insulating thermally conductive sheet was produced in the same manner as in Example 1, except that BN particles and PTFE were mixed in a ratio (weight ratio) of 80:20. More specifically, they were mixed so that the content of the BN particles in the resulting electrically insulating thermally conductive sheet was 80% by weight. The thermal conductivities of this sheet were measured in the same manner as in Example 1, and further the porosity thereof was measured in the following manner. Table 2 shows the measurement results. The electrically insulating thermally conductive sheet of Example 6 is the same as the electrically insulating thermally conductive sheet of Example 4.

<Porosity>

The weight and the volume of the electrically insulating thermally conductive sheet were measured to calculate a measured density based on the measurement results. The porosity was calculated using this measured density and the true density by the following equation:

Porosity(%)=(1−measured density/true density)×100

### Example 7

In Example 7, an electrically insulating thermally conductive sheet was produced in the same manner as in Example 1, except that BN particles, PTFE, and PFA (“MP-10” (trade name) manufactured by Du Pont-Mitsui Fluorochemicals Co., Ltd.) were mixed in a ratio (weight ratio) of 80:10:10. More specifically, they were mixed so that the content of the BN particles in the resulting electrically insulating thermally conductive sheet was 80% by weight. The thermal conductivities and the porosity of this sheet were measured in the same manner as in Example 6. Table 2 shows the measurement results.

### Example 8

In Example 8, an electrically insulating thermally conductive sheet was produced in the same manner as in Example 1, except that BN particles (“UHP-1” (trade name) manufactured by Showa Denko K.K.) and PTFE were mixed in a ratio (weight ratio) of 80:20. More specifically, they were mixed so that the content of the BN particles in the resulting electrically insulating thermally conductive sheet was 80% by weight. The thermal conductivities and the porosity of this sheet were measured in the same manner as in Example 6. Table 2 shows the measurement results.

### Example 9

In Example 9, an electrically insulating thermally conductive sheet was produced in the same manner as in Example 7, except that BN particles (“UHP-1” (trade name) manufactured by Showa Denko K.K.), PTFE, and PFA were mixed in a ratio (weight ratio) of 80:10:10. More specifically, they were mixed so that the content of the BN particles in the resulting electrically insulating thermally conductive sheet was 80% by weight. The thermal conductivities and the porosity of this sheet were measured in the same manner as in Example 6. Table 2 shows the measurement results.

### Example 10

In Example 10, an electrically insulating thermally conductive sheet was produced in the same manner as in Example 7, except that BN particles (“PT620” (trade name) manufactured by Momentive Performance Materials Inc.), PTFE, and PFA were mixed in a ratio (weight ratio) of 80:10:10. More specifically, they were mixed so that the content of the BN particles in the resulting electrically insulating thermally conductive sheet was 80% by weight. The thermal conductivities and the porosity of this sheet were measured in the same manner as in Example 6. Table 2 shows the measurement results.

### Example 11

In Example 11, an electrically insulating thermally conductive sheet was produced in the same manner as in Example 7, except that BN particles (“PT110” (trade name) manufactured by Momentive Performance Materials Inc.), PTFE, and PFA were mixed in a ratio (weight ratio) of 80:10:10. More specifically, they were mixed so that the content of the BN particles in the resulting electrically insulating thermally conductive sheet was 80% by weight. The thermal conductivities and the porosity of this sheet were measured in the same manner as in Example 6. Table 2 shows the measurement results.

TABLE 2

| | Example 6 | Example 7 | Example 8 | Example 9 | Example 10 | Example 11 |
|---|---|---|---|---|---|---|
| Type of BN particles | HP-40 | HP-40 | UHP-1 | UHP-1 | PT620 | PT110 |
| | (Agglomerate) | (Agglomerate) | (Flake) | (Flake) | (Agglomerate) | (Flake) |
| Particle size of BN | 5 to 40 | 5 to 40 | 8 to 10 | 8 to 10 | 300 to 350 | 45 |
| particles | | | | | | |
| (μm) | | | | | | |
| Mixing ratio | 8/2/0 | 8/1/1 | 8/2/0 | 8/1/1 | 8/1/1 | 8/1/1 |
| (BN/PTFE/PFA) | | | | | | |
| In-plane thermal | 11.4 | 16.4 | 9.5 | 19.9 | 18.7 | 35 |
| conductivity | | | | | | |
| (W/mK) | | | | | | |
| Through-thickness | 6.6 | 7.9 | 6.4 | 3.8 | 6.6 | 3.8 |
| thermal conductivity | | | | | | |
| (W/mK) | | | | | | |
| Porosity | 23.7 | 13.9 | 31.7 | 26.3 | 13.9 | 10 |
| (%) | | | | | | |

The sheets containing the same amount of the same type of BN particles were compared based on the results shown in Table 2. This comparison demonstrates that an electrically insulating and thermally conductive sheet containing a fluororesin composed of PTFE and PFA achieved a lower porosity and a higher thermal conductivity than that containing a fluororesin consisting of PTFE. The comparison between Example 10 and Example 11 shows that the thermal conductivity was further increased when agglomerated BN particles, that is, BN particles with larger particle size, were used.

Next, the heat dissipation capabilities of the electrically insulating thermally conductive sheet of the present invention (Example 7) and conventional heat dissipating sheets (Comparative Examples 2 to 5) below were evaluated. The thermal conductivities of these sheets were also measured in the same manner as in Example 1. Table 3 shows the results. The evaluation method of the heat dissipation capabilities is also described below.

### Comparative Example 2

A graphite sheet (GS) manufactured by TYK Corporation was used as a heat dissipating sheet for Comparative Example 2.

### Comparative Example 3

An Al sheet was used as a heat dissipating sheet for Comparative Example 3.

### Comparative Example 4

A polyimide (PI) film (“Upilex” (trade name) manufactured by Ube Industries, Ltd.) was used as a heat dissipating sheet for Comparative Example 4.

### Comparative Example 5

A sheet composed of PI and BN particles was used as a heat dissipating sheet for Comparative Example 5. BN particles (“UHP-1” (trade name) manufactured by Showa Denko K.K.) were mixed with a polyamide acid (PMDA-ODA) that is a polyimide precursor so that the content of the BN particles in the resulting mixture was 45% by volume. The mixture was applied to a glass sheet, and fully cured at 320° C. for imidization. A sheet thus obtained was used as a heat dissipating sheet for Comparative Example 5.

<Evaluation of Heat Dissipation Capabilities>

Each of the sheets to be evaluated was cut into square pieces of 50 mm×50 mm, and one of the pieces was used as a test sample. This test sample was bonded to a cement resistor (“PWB-5W-47Q” (trade name) with dimensions of 10 mm×8 mm×22 mm, manufactured by TAKMAN Electronics Co., Ltd.) with an adhesive (“No. 501H” (trade name) manufactured by Nitto Denko Corporation). The temperatures of the surface of the cement resistor, the surface of the test sample (the surface opposite to the surface bonded to the cement resistor, that is, the back surface of the test sample), and outside air were each measured at 4.8 W (0.32 A×15V) with a type-K thermocouple, and the outputs of the thermocouple were monitored with a data logger (“NR600” manufactured by Keyence Corporation).

TABLE 3

| | | Com- | Com- | Com- | Com- |
|---|---|---|---|---|---|
| | | para- | para- | para- | para- |
| | | tive | tive | tive | tive |
| | | Exam- | Exam- | Exam- | Exam- |
| | Example 7 | ple 2 | ple 3 | ple 4 | ple 5 |
| Composition | BN | GS | AI | PI | BN/PI |
| | Fluororesin | | | | |
| | (PTFE/PFA) | | | | |
| Through-thickness | 7.9 | 2.4 | 247 | 0.23 | 6 |
| thermal | | | | | |
| conductivity | | | | | |
| (W/mK) | | | | | |
| In-plane thermal | 16.4 | 370 | 247 | — | 9 |
| conductivity | | | | | |
| (W/mK) | | | | | |
| Thickness | 0.4 | 0.5 | 2 | 0.075 | 0.12 |
| (mm) | | | | | |
| T1 | 140 | 109 | 120 | 175 | 156 |
| (Temperature | | | | | |
| of surface of | | | | | |
| cement | | | | | |
| resistor | | | | | |
| (° C.)) | | | | | |
| T2 | 99 | 61 | 70 | 163 | 131 |
| (Temperature | | | | | |
| of back | | | | | |
| surface of | | | | | |
| test sample | | | | | |
| (° C.)) | | | | | |

The results show that the heat dissipation capability of the electrically insulating thermally conductive sheet of Example 7 is inferior to the capabilities of the graphite sheet of Comparative Example 2 and the Al sheet of Comparative Example 3, but superior to those of the PI film of Comparative Example 4 and the sheet of Comparative Example 5 composed of PI and BN particles. It should be noted here that the electrically insulating thermally conductive sheet of Example 7 is an electrically insulating sheet, but the graphite sheet of Comparative Example 2 and the Al sheet of Comparative Example 3 are electrically conductive sheets. Therefore, an insulating layer must be additionally provided to use the graphite sheet of Comparative Example 2 or the Al sheet of Comparative Example 3 in an electronic apparatus or the like, which is disadvantageous. Furthermore, the temperature of outside air rose when the sheet of Comparative Example 5 composed of PI and BN particles was used. In contrast, in the electrically insulating thermally conductive sheet of Example 7, the in-plane heat diffusion was observed, and thus the temperature of outside air was lower than that measured in Comparative Example 5.

The above results demonstrate that the electrically insulating thermally conductive sheet of the present invention has a combination of electrically insulating properties and excellent heat dissipation capability, which has never been obtained before. In conclusion, the electrically insulating thermally conductive sheet of the present invention has advantages, as a heat dissipating member for use in an electronic apparatus or the like, over conventionally available heat dissipating sheets.

### INDUSTRIAL APPLICABILITY

The electrically insulating thermally conductive sheet obtained by the present invention has high heat dissipation capability and high mechanical strength, and does not contain any components having an adverse effect on an electronic apparatus when it is used therein. Therefore, the sheet of the present invention, as a heat dissipating member, can be applied to all types of electronic apparatuses.

1. A method of producing an electrically insulating thermally conductive sheet, the method comprising the steps of:
(I) preparing a plurality of sheet materials consisting essentially of a fluororesin containing polytetrafluoroethylene, thermally conductive inorganic particles, and a forming aid;
(II) stacking the plurality of sheet materials on one another and rolling the stacked sheet materials together; and
(III) removing the forming aid.

2. The method of producing an electrically insulating thermally conductive sheet according to claim 1, wherein the thermally conductive inorganic particles consist essentially of boron nitride.

3. The method of producing an electrically insulating thermally conductive sheet according to claim 1, further comprising the step of (IV) press-forming a sheet article obtained in the step (III).

4. The method of producing an electrically insulating thermally conductive sheet according to claim 3, wherein in the step (IV), the sheet article is press-formed at a temperature within a temperature range for sintering polytetrafluoroethylene.

5. The method of producing an electrically insulating thermally conductive sheet according to claim 1, wherein the step (I) and the step (II) are repeated alternately.

6. The method of producing an electrically insulating thermally conductive sheet according to claim 5, wherein the rolling direction is changed each time the step (II) is repeated.

7. The method of producing an electrically insulating thermally conductive sheet according to claim 1, wherein the fluororesin is composed of
(A) polytetrafluoroethylene,
(B) polytetrafluoroethylene and a tetrafluoroethylene-perfluoroalkyl vinyl ether copolymer, or
(C) polytetrafluoroethylene and a tetrafluoroethylene-hexafluoropropyrene copolymer.

8. An electrically insulating thermally conductive sheet obtained by the method according to claim 1.

9. An electrically insulating thermally conductive sheet consisting essentially of a fluororesin containing polytetrafluoroethylene, and thermally conductive inorganic particles, wherein
the sheet has an in-plane thermal conductivity of 5 to 50 W/mK, a through-thickness thermal conductivity of 1 to 15 W/mK, and a withstand voltage of 5 kV/mm or more.

10. The electrically insulating thermally conductive sheet according to claim 9, wherein the in-plane thermal conductivity is higher than the through-thickness thermal conductivity.

11. The electrically insulating thermally conductive sheet according to claim 9, wherein the thermally conductive inorganic particles consist essentially of boron nitride.

12. The electrically insulating thermally conductive sheet according to claim 9, wherein the fluororesin is composed of
(A) polytetrafluoroethylene,
(B) polytetrafluoroethylene and a tetrafluoroethylene-perfluoroalkyl vinyl ether copolymer, or
(C) polytetrafluoroethylene and a tetrafluoroethylene-hexafluoropropyrene copolymer.

13. The electrically insulating thermally conductive sheet according to claim 8, wherein the sheet has a tensile elongation of 1 to 400%.

14. The electrically insulating thermally conductive sheet according to claim 8, wherein the sheet contains 40 to 95% by weight of the thermally conductive inorganic particles.

15. A heat dissipating member comprising the electrically insulating thermally conductive sheet according to claim 8.

16. The electrically insulating thermally conductive sheet according to claim 9, wherein the sheet has a tensile elongation of 1 to 400%.

17. The electrically insulating thermally conductive sheet according to claim 9, wherein the sheet contains 40 to 95% by weight of the thermally conductive inorganic particles.

18. A heat dissipating member comprising the electrically insulating thermally conductive sheet according to claim 9.
